(19) United States
(12) Patent Application Publication
(10) Pub. No.: US 2017/0200313 A1
(43) Pub. Date: Jul. 13, 2017

(54) APPARATUS AND METHOD FOR PROVIDING PROJECTION MAPPING-BASED AUGMENTED REALITY

(71) Applicant: ELECTRONICS AND TELECOMMUNICATIONS RESEARCH INSTITUTE, Daejeon (KR)

(72) Inventors: Ki Suk LEE, Daejeon-si (KR); Dae Hwan KIM, Sejong-si (KR); Hang Kee KIM, Daejeon-si (KR); Hye Mi KIM, Daejeon-si (KR); Ki Hong KIM, Sejong-si (KR); Su Ran PARK, Daejeon-si (KR)

(21) Appl. No.: 15/241,543

(22) Filed: Aug. 19, 2016

(30) Foreign Application Priority Data
Jan. 7, 2016 (KR) 10-2016-0002214

(51) Int. Cl. G06T 19/00; G06K 9/00; H04N 9/31; G06T 7/00; G06T 17/20; G06T 15/50; G06T 19/20; G06K 9/62

(52) U.S. Cl. CPC G06T 19/006; G06T 19/20; G06K 9/00208; G06K 9/00335; G06K 9/6256; G06T 7/0046; G06T 17/20; G06T 15/503; H04N 9/3147; G06T 2207/10028; G06T 2207/20081; G06T 2207/30196

(57) ABSTRACT

An apparatus and method for providing projection mapping-based augmented reality (AR). According to an exemplary embodiment, the apparatus includes an input to acquire real space information and user information; and a processor to recognize a real environment by using the acquired real space information and the acquired user information, map the recognized real environment to a virtual environment, generate augmented content that changes corresponding to a change in space or a user's movement, and project and visualize the generated augmented content through a projector.

### CROSS-REFERENCE TO RELATED APPLICATION(S)

This application claims priority from Korean Patent Application No. 10-2016-0002214, filed on Jan. 7, 2016, in the Korean Intellectual Property Office, the entire disclosure of which is incorporated herein by reference for all purposes.

### BACKGROUND

1. Field

The following description relates to a technology for providing content, and more specifically, to a technology for providing content of augmented reality (AR) where a virtual world is combined with the real world.

2. Description of the Related Art

In order to increase an experiencer's absorption, content has been proposed in various ways through a projection, e.g., media façade that represents content by the projection of content to a large building, or exhibition space being represented in media art. Most of these examples are the forms in which an image that is made in advance is projected to a fixed environment.

In this composition, a user cannot see an image that is projected to himself/herself, and so only other people can see, which means that it does not seem to increase absorption of a realistic experience. In addition, in terms of the use of a display for absorption, general experience devices apply a user's movement as it is to virtual space that is proposed through information input by movement recognition sensors, and visualize the content in TV or head mounted display (HMD), etc. These devices increase the absorption because they map a user's movement to virtual space, but due to the limit in a flat and narrow visualization area, it is hard for a display, such as TV, to provide a user with a sufficient realistic experience. HMD can maximize the absorption as it is worn on a user's head, but because it is uncomfortable to wear, and the exterior cannot be seen, there are difficulties in naturally interacting with an external environment.

### SUMMARY

The following description relates to an apparatus and method for providing projection mapping-based augmented reality (AR) to provide a user with new-type realistic experiences.

In one general aspect, an apparatus for providing augmented reality (AR) includes: an input to acquire real space information and user information; and a processor to recognize a real environment by using the acquired real space information and the acquired user information, map the recognized real environment to a virtual environment, generate augmented content that changes corresponding to a change in space or a user's movement, and project and visualize the generated augmented content through a projector.

The input may acquire in advance the user information comprising a user's skeleton information and body information of each body part; and the processor may use the user information so that when the augmented content is projected to a user's body, the augmented content matches the user's body.

The input may acquire point cloud information of three-dimensional space with regard to real space in which a user and a three-dimensional item model are all removed, match the point cloud information to a three-dimensional background model that is made in advance to be simplified, and register the matched information; and acquire an image and a depth information map regarding each three-dimensional item model used in the augmented content, as well as point cloud information that is made using the image and the depth information map, match the point cloud information to the three-dimensional background model, and register the matched information.

The processor may include: an interaction processor to recognize an object by using the real space information and the user information, recognize the real environment comprising the user's movement from the recognized object, calculate an interaction between the recognized real environment and the virtual environment, combine the virtual environment with the real environment, and accordingly generate the augmented content; and a projection visualizer to project and visualize the augmented content, generated by the interaction processor, through the projector.

The interaction processor may recognize the object by analyzing real space through image processing and machine learning which are performed based on the real space information comprising depth information and point cloud information.

The interaction processor may calculate the interaction between real space and virtual space, divide space by using a three-dimensional background model that is made in advance and simplified in order to improve a reaction speed, perform pre-matching for each divided space, and search for an area, which is good enough for the object to be added to, on space where the augmented content is to be represented.

The projection visualizer may acquire mapping parameters between real space and virtual space, and combine the mapping parameters so that the real space and the virtual space are mapped equally.

The projection visualizer may represent the augmented content by training and registering a three-dimensional background model that is made in advance by the input and simplified, searching for an object location on space, where the augmented content is to be represented, by using data acquired by the input, and replacing the searched object location with a virtual object mesh that is made in advance and simplified.

The projection visualizer may in response to the augmented content being projected to a user's body, render a virtual object mesh in three-dimensional space without any change by using user body information acquired in advance by the input, wherein the virtual object mesh is made in advance and simplified.

The projection visualizer may perform edge blending and masking on an image to process an area overlapped by several projectors.

The processor may further include a content sharing processor to share and synchronize the augmented content with other users existing in remote areas so that the users experience the augmented content together.

The processor may further include a content logic processor to support the augmented content to progress according to a scenario logic, and provide augmented content visualization data to the projection visualizer.

In another general aspect, a method of providing AR includes: acquiring real space information and user information; recognizing an object by using the acquired real space information and the acquired user information, recognizing a real environment comprising a user's movement from the recognized object, calculating an interaction between the recognized real environment and a virtual environment, combining the virtual environment with the real environment, and accordingly generating augmented content; and projecting and visualizing the generated augmented content through a projector.

The acquiring of the real space information and the user information may include: acquiring point cloud information of three-dimensional space with regard to real space in which a user and a three-dimensional item model are all removed, matching the point cloud information to a three-dimensional background model that is made in advance to be simplified, and registering the matched information; and acquiring an image and a depth information map regarding each three-dimensional item model used in the augmented content, as well as point cloud information that is made using the image and the depth information map, matching the point cloud information to the three-dimensional background model, and registering the matched information.

The generating of the augmented content may include recognizing an object by analyzing real space through image processing and machine learning, which are performed based on the real space information comprising depth information and point cloud information.

The generating of the augmented content may include calculating the interaction between real space and virtual space, dividing space by using a three-dimensional background model that is made in advance and simplified in order to improve a reaction speed, performing pre-matching for each divided space, and searching for an area, which is good enough for the object to be added to, on space where the augmented content is to be represented.

The generating of the augmented content may include acquiring mapping parameters between real space and virtual space, and combining the mapping parameters so that the real space and the virtual space are mapped equally.

The generating of the augmented content may include: representing the augmented content by training and registering a three-dimensional background model that is made in advance and simplified, by searching for an object location on space, where the augmented content is to be represented, using the real space information and the user information, and by replacing the searched object location with a virtual object mesh that is made in advance and simplified.

The generating of the augmented content may in response to the augmented content being projected to a user's body, render a virtual object mesh as it is in three-dimensional space by using user body information, wherein the virtual object mesh is made in advance and simplified.

The method may further include sharing and synchronizing the augmented content with other users existing in remote areas so that the users experience the augmented content together.

Other features and aspects may be apparent from the following detailed description, the drawings, and the claims.

### BRIEF DESCRIPTION OF THE DRAWINGS

FIG. 1 is a diagram illustrating a system for providing projection mapping-based augmented reality (AR) according to an exemplary embodiment.

FIG. 2 is a diagram illustrating an apparatus for providing the augmented reality (AR) in FIG. 1 according to an exemplary embodiment.

FIG. 3 is a reference diagram illustrating a projection mapping-based realistic experience environment according to an exemplary embodiment.

FIG. 4 is a reference diagram illustrating an example of projection to a user's body according to an exemplary embodiment.

FIG. 5 is a reference diagram illustrating an example of interaction between a user's operation and a projected virtual object according to an exemplary embodiment.

FIG. 6 is a flowchart illustrating a method of providing projection mapping-based augmented reality (AR) according to an exemplary embodiment.

FIG. 7 is a reference diagram illustrating an example of acquiring user information according to an exemplary embodiment.

FIG. 8 is a diagram illustrating the outward appearance of a reflector of a projector according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

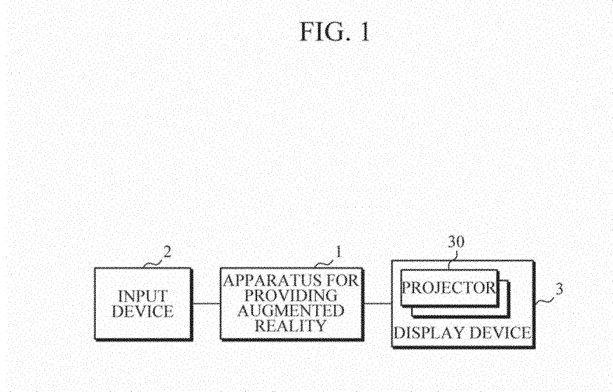

FIG. 1 is a diagram illustrating a system for providing projection mapping-based augmented reality (AR) according to an exemplary embodiment.

Referring to FIG. 1, a system for providing augmented reality (AR) includes an apparatus 1 for providing augmented reality (AR), an input device 2, and a display device 3. FIG. 1 illustrates the input device 2 and the display device 3 that are physically separated from the apparatus 1, but according to an exemplary embodiment, the input device 2 may be included in the apparatus 1, or the display device 3 may be included in the apparatus 1.

The apparatus 1 acquires real space information and user information from the input device 2, and maps a real environment to a virtual environment by using the acquired real space information and the user information to generate augmented content that dynamically changes. Then, the generated augmented content is projected and visualized through the display device 3 that includes a projector 30. Here, the real environment may be a user or real object existing in real space, and the virtual environment may be virtual space or a virtual object.

The input device 2 provides real space information and the use information to the apparatus 1. The input device 2 may acquire and provide image information regarding a user moving in the real space. In this case, the input device 2 may be a camera that acquires general images, an RGB camera that acquires color and depth information, or the like. The input device 2 may acquire a user's movement information by using a light, which is then provided. In this case, the input device 2 may be light Detection and ranging (LIDAR), etc. The LIDAR is laser radar, which uses a laser light as electromagnetic waves. The user information may include a user's body information, such as a user's joint location and length information thereof.

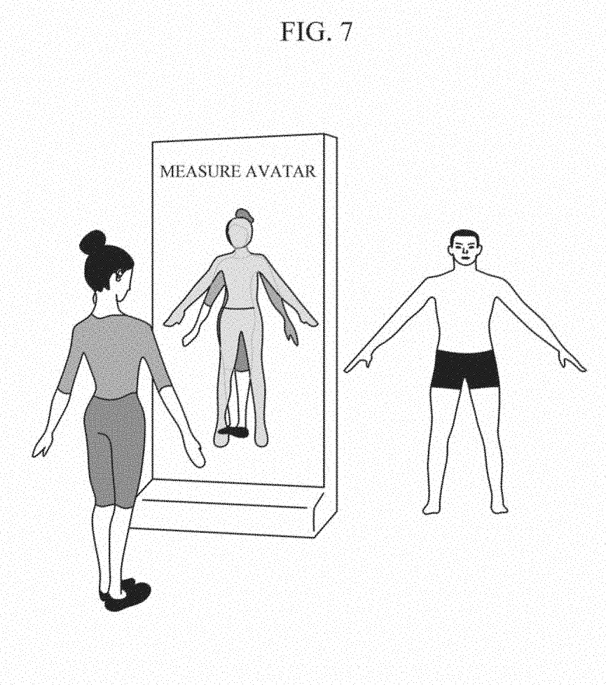

The input device 2 is configured to acquire the user information, as well as skeleton information and the respective body information, and then project augmented content to a user's body by using the acquired information, so the augmented content may be precisely projected to be fit for the user's body. The exemplary embodiment thereof will be specifically described with reference to FIG. 7.

The display device 3 includes at least one projector 30. The apparatus 1 projects augmented content through the projector 30. Recently, due to a light-emitting diode (LED), it is possible to use a light source that is bright but has a low maintenance expense and a long lifespan, so a lot of mini projectors or low-cost projectors are widely used, and a projection environment may be built even with a considerably small amount of money.

It may be possible to project the augmented content to wider space with a less number of projectors through the following operations in order to secure a wider projection area: increasing a projection distance through mirror reflection; or making a reflection surface appropriate for a projection surface by using a 3D printer and then executing mirror reflection coating.

In one exemplary embodiment, in order to provide a realistic experience to a user, the apparatus 1 dynamically visualizes a virtual object to real space, a real object, and a user by using the projector 30 and enables the virtual environment, represented through a projection mapping technique, to interact with the real environment, thereby providing realistic augmented content. Also, if the augmented content is extended, users in remote areas may run it together as if they gathered in the same place.

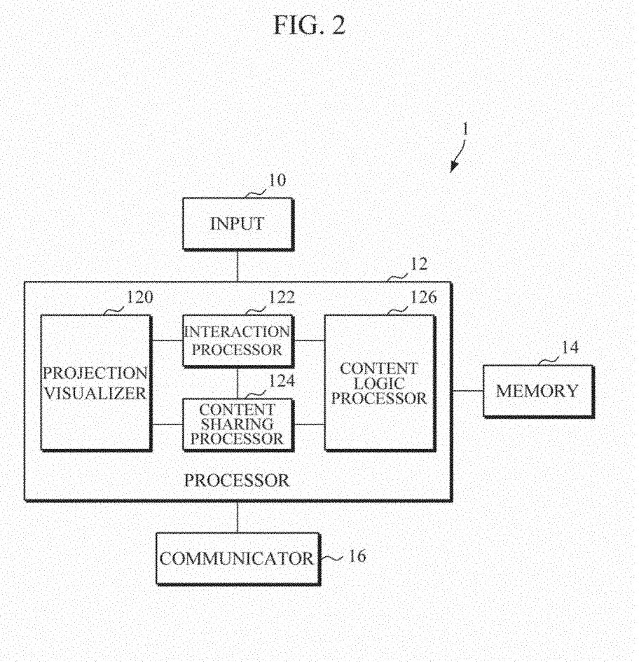

FIG. 2 is a diagram illustrating an apparatus for providing the augmented reality (AR) in FIG. 1 according to an exemplary embodiment.

Referring to FIGS. 1 and 2, an apparatus 1 for providing AR includes an input 10, a processor 12, memory 14, and a communicator 16.

The input 10 acquires, from an input device 2, real space information and user information for the projection in a user's experience environment. The processor 12 generates augmented content by mapping a real environment to a virtual environment based on the acquired real space information and user information which are acquired by the input 10, and projects and visualizes the generated augmented content through a projector 30. The communicator 16 transmits and receives the augmented content and information for synchronization, so that the augmented content may be shared and synchronized with the apparatuses 1 of other users existing in remote areas, and they may experience it together. The memory 14 stores information for performing the operations of the apparatus 1, and information generated according to the performance of the operations. The memory 14 stores the mapping information between the real environment and the virtual environment, and stores model data of a virtual object, which is made in advance and corresponds to a real object. The model data of the virtual object may change by the comparison between characteristics of the real space, which is recognized based on the real space information and the user information, and the model data of a virtual object that is pre-stored.

In one exemplary embodiment, the processor 12 includes a projection visualizer 120, an interaction processor 122, a content sharing processor 124, and a content logic processor 126.

The interaction processor 122 recognizes a real object by using real space information and user information, and recognizes a real environment including a user's operation from the recognized real object. Then, the interaction processor 122 calculates the interaction between the recognized real environment and a virtual environment, combines the virtual environment with the real environment, and accordingly generates augmented content. The projection visualizer 120 projects and visualizes the augmented content, generated by the interaction processor 122, through the projector 30. The content sharing processor 124 shares and synchronizes the augmented content with other users in remote areas, so that they experience together. The content logic processor 126 provides augmented content visualization data, so that the projection visualizer 120 may visualize the augmented content according to a scenario.

Hereinafter, each of the components will be specifically described.

The input 10 acquires, from the input device 2, point cloud information, user skeleton information, and information of the video that is being played, with regard to real three-dimensional space where the augmented content will be represented. Also, the input 10 acquires information for recognizing and tracking various real objects existing in an experience space.

In order to easily acquire user information, the input 10 may acquire a user's skeleton information and body information in advance by using the input device 2 that is separately configured. In this case, the processor 12 may precisely project the augmented content to be exactly fit for a user's body by using the acquired information. Moreover, the processor 12 may store user information to reuse it later.

In one exemplary embodiment, the input 10 acquires information through two steps in advance in order to build an initial environment. A first step is to acquire the point cloud information of three-dimensional space with regard to real space in which a user and a three-dimensional item model are all removed, match the information to a three-dimensional background model that is simplified through modelling in advance, and register the matched information. A second step is to acquire an image and a depth information map regarding each three-dimensional item model used in the augmented content, as well as point cloud information that is made using the image and the depth information map; match the point cloud information to the three-dimensional background model that is made in advance and simplified; and register the matched information. The simplified three-dimensional background model information where the augmented content operates may be formed by simplifying the acquired and recovered space information, but it may be modelled in advance and used for more efficient processing. In addition, the input 10 acquires a user's body information in advance and makes it ready, so that the length of each joint, facial pictures, etc., may be used in augmented content.

The projection visualizer 120 combines virtual space to real space to generate augmented content, and visualizes the generated augmented content through one or more projectors 30 and various displays. To this end, mapping parameters are acquired through a calibration step of linking the input device 2 to the projector 30, so as to calculate the correlation between the real space for projecting the augmented content and a virtual three-dimensional coordinate space. For example, an intrinsic parameter and an extrinsic parameter of the input device 2 and the projector 30 are acquired in the calibration step, and then they are combined together so that the virtual space and the real space may be mapped equally. In addition, in order to process the area overlapped by several projectors, the projection visualizer 120 may expand the space for experience through edge blending, masking, etc., on the image. The above-mentioned processes may be performed based on an association analysis based on various patterns that are used in computer vision.

It may be possible to project the augmented content to wider space with a less number of projectors through the following operations in order to secure a wider projection area: increasing a projection distance to enlarge a projection surface through mirror reflection, or making a reflection surface with a curve, which is appropriate for the projection surface by using a 3D printer, and then executing mirror reflection coating thereon.

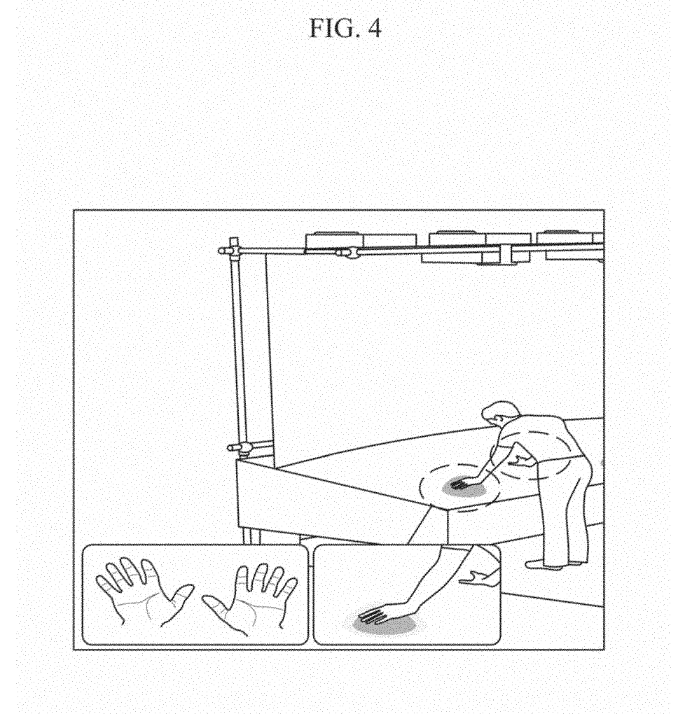

When the interaction processor 122 calculates the interaction between the real space and the virtual space by using the information that is acquired by the input 10, and applies it to the augmented content, the projection visualizer 120 represents the augmented content through the projector 30 in the virtual space that is mapped to the real space. The real space may be, for example, the surface of a wall, the surface of a floor, the surface of a three-dimensional item object, and a part of a user's body. In a case of the three-dimensional item object, a three-dimensional background model, which is made in advance and simplified, is trained and then registered; an object location is searched for on space, where augmented content will be represented, by using the data acquired by the input 10; and then the searched object location is replaced with a virtual object mesh that is made in advance and simplified, so the augmented content is presented. Since the location information on space may have a different relative coordinate system depending on each input device 2, the information regarding all the input device 2 is relatively adjusted, calculated, and processed based on the registered three-dimensional background model. As described above, FIG. 4 illustrates an example, in which the interaction processor 122 calculates an interaction according to the progression of an augmented content scenario of the content logic processor 126 based on the information acquired by the input 10, so the augmented content is visualized by the projection visualizer 120.

The interaction processor 122 analyzes a change in the space based on the information acquired by the input 10, such as real space information, user information, and three-dimensional information of real objects existing in the space where the augmented content is projected, recognizes user movements, and processes the interaction between the real space and the virtual space.

As the simplest form, there is a method of searching for the real object by attaching a color or infrared ray pattern-based marker on a real object, but it may cause a problem of reducing a quality of the image that is projected onto the real object, so the interaction processor 122 analyzes a change in the space based on the three-dimensional information of the real object.

In order to analyze space needed for the use of an augmented content scenario and recognize and use an object, image processing and machine learning may be used based on depth information acquired by a depth sensor, which is one of input devices, or an iterative closest point, etc., may be used based on point cloud information.

Since a projection environment where augmented content operates is generally implemented in dark space, depth information acquired by a depth sensor is mostly used, and color information is additionally used so as to analyze a real image. In order to acquire learning data of an object that needs to be recognized, the learning data is acquired by putting a three-dimensional background model in a background. To effectively acquire the learning data, a depth information map and a color information map are linked together in the manner of marking a specific location or surface of a real object in color or putting a tape thereon to acquire the learning data, so that it may be used as an answer set for learning. Feature information is extracted from the acquired depth information map, codes the feature information to distinguish objects used in augmented content, and searches for an object's location on space. Machine learning therefor may be support vector machine (SVM) or deep learning.

In a step of calculating real-time interaction through machine learning, the interaction processor 122 divides space into the appropriate number of grids by using a three-dimensional background model that is made in advance and simplified in order to improve a reaction speed, executes pre-matching for each part, and accordingly searches for an area, which is good enough for an object to be added to, on the space where the augmented content will be represented, thereby causing a precise analysis. Also, in a case of objects existing in space excluding a user's body, the objects are included into background information to secure the properties of real time

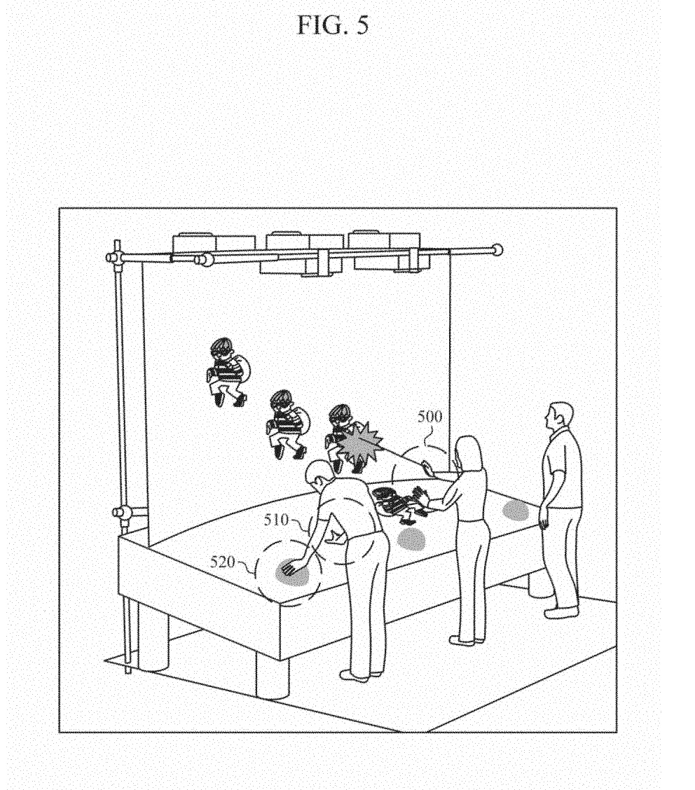

Since a correlation between a projection space and a real space is calculated by the projection visualizer 120, the interaction processor 122 may perform the interaction of analyzing a user's movement in real space based on recognized object information and then applying the analysis result to augmented content. The real space information is a depth map acquired by the input 10, and point cloud information using the depth map, which are then simplified, so that the simplified point cloud information is matched to a three-dimensional mesh including the same space information. When the interaction thereof is performed, the three-dimensional mesh registered in a simplified form in advance is used, and different types of geometric processing methods are needed according to various augmented content scenarios. A directing point may be acquired based on the acquired location and angle of each skeleton of users, and a collision process between a simplified three-dimensional mesh and a straight line may help to know that a user has interacted with a virtual object existing at which location. As such, in a manner that enables the virtual meshes that equal to the real projection space to exist, an augmented content scenario that the augmented content interacts with space may be implemented. Examples thereof are illustrated in FIG. 5.

All interactions are performed based on an interactive mapping relation between virtual space and real space where an object is projected, and are performed through various arithmetic operations in three-dimensional model space. The augmented content scenario that the augmented content interacts with space may be implemented in a manner that enables the virtual meshes that equal to the real projection space to exist according to the contents of changed augmented content. Also, a real object is added to space, which is then recognized, so the real object may be used in the augmented content. Thus, it is possible to create various interactive augmented content for, for example, rolling a dice or casting Yut sticks in reality to be put as input into a virtual game board, making a structure to prevent an attack from a counterpart in a remote area, changing the structure to change an environment, or the like.

Particularly, in a case where the augmented content is projected onto a user's body, rendering a user's body information acquired in advance by an input 10, e.g., a length of a joint, in space in a format that is simplified in advance may increase accuracy more, rather than acquiring a user's joint information in real time.

The content sharing processor 124 provide a support so that experiences may be shared with other users existing in a remote area through a network. The following information is shared through a network: user information and a location/type of a real object, which are the information existing in real space; virtual object information, which is the virtual information existing in augmented content; and synchronization information for progressing the augmented content. Based on a three-dimensional background model that is simplified, in which the augmented content progresses, virtual space coordinates between remote areas are linked to extend virtual augmented content space. Such shared and extended virtual space may be proposed and shared in a manner that overlays information, acquired from a remote area, on an augmented content background in a display as if users existing in remote areas are seen through glass.

A content logic processor 126 links an interaction processor 122 to the content sharing processor 124 so that the augmented content may progress according to a scenario logic. Also, the content logic processor 126 provides augmented content visualization data to a rendering engine for generating a three-dimensional scene to be proper for a projection visualizer 120 that visualizes augmented content, and performs a management for a continuous operation of the augmented content. The augmented content visualization data may be generated using model data that is made in advance.

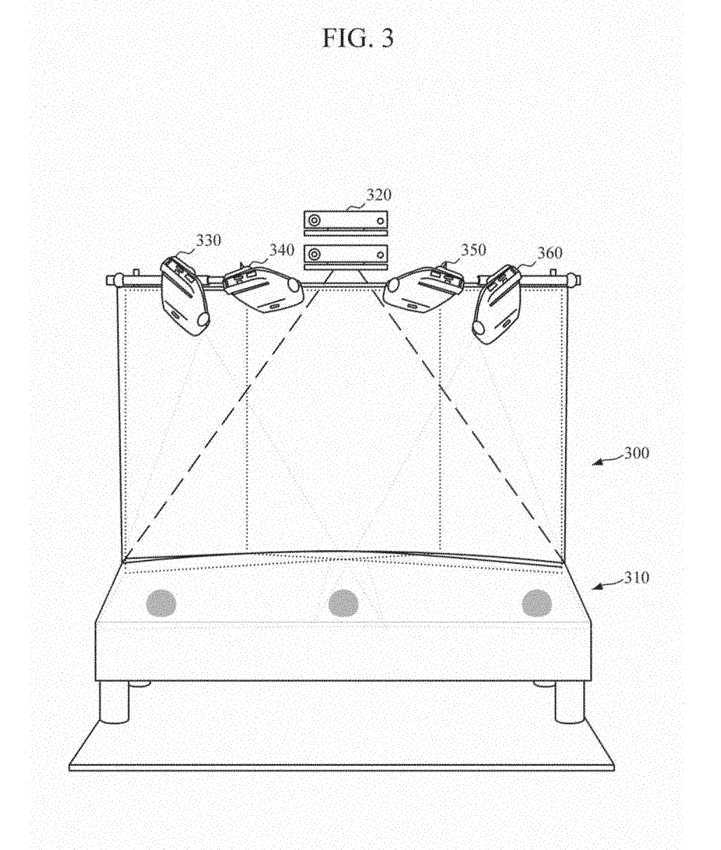

FIG. 3 is a reference diagram illustrating a projection mapping-based realistic experience environment according to an exemplary embodiment.

Referring to FIG. 3, in a projection mapping-based realistic experience environment, a structure thereof may be transformed into various forms, but in order to help the comprehension, an experience environment of a form in which a rear wall 300 and a table 310 are combined together as illustrated in FIG. 3 is provided as one example. Input devices are installed in a location where information, which has small shading and has the widest area by a user, is acquirable and representable considering a structure of experience space. For example, as illustrated in FIG. 3, Kinect 320 is located on the top thereof, and in this case, an apparatus for providing AR acquires real space information and user information from an input device that is located on the top thereof. As one example of a projector being installed, the apparatus may include: projectors for the table top being installed on respective left and right sides (Table_top_L projector and Table_top_R projector) 330 and 360; and projectors for background being installed on respective on respective left and right sides (BG_L projector and BG_R projector) 330 and 360, as illustrated in FIG. 3.

FIG. 4 is a reference diagram illustrating an example of projection to a user's body according to an exemplary embodiment.

Referring to FIG. 4, in a case in which augmented content is projected onto a user's body, not acquiring a user's joint information in real time, but rendering a user's body information acquired in advance, e.g., a length of a joint, in a simplified format may increase accuracy more.

FIG. 5 is a reference diagram illustrating an example of interaction between a user's operation and a projected virtual object according to an exemplary embodiment.

Referring to FIG. 5, a user's movement A is bending and then straightening his/her arm to shoot an electric light beam, which may be shot by straightening one hand or both hands at the same time, and the user may change his/her hand. In a case of the movement A, a straight line may be acquired based on location and degree information on joints of a user's arm, which are obtained in advance, and through a collision process of between a three-dimensional mesh of space and the straight line, it may be known that the user has interacted with a virtual object in which location.

The user's movement B is hitting a table with one hand or with both hands. For example, when both hands hit the table at the same time, a strong magnetic field may occur, thereby hunting robot geese around hands all at once. In the case of the movement B, through the detection of a speed of the joints of the user's arm, it may be known how the user has interacted with the virtual object based on the detection speed.

The user's movement C is holding a half sphere, and specifically, through the introduction of a concept of charging electric force, light is projected over a user's wrist when the user touches the sphere on the top of the table for a predetermined period of time. In the case of the movement C, it may be detected that the user's hand is put in a certain location on the table, and then it may be known how the user has interacted with the virtual object using a depth value of the hand.

As described above, a user may perform various interactions, such as touching, hitting, and tapping a certain part of space which is projected in various forms. In this case, as augmented content is visualized being linked between real space and virtual space, a scenario that supports interactions having various effects may be implemented.

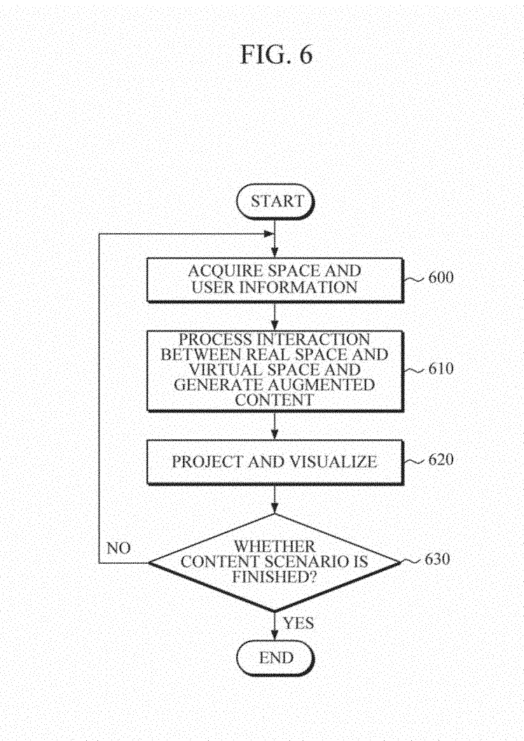

FIG. 6 is a flowchart illustrating a method of providing projection mapping-based augmented reality (AR) according to an exemplary embodiment.

Referring to FIG. 6, an apparatus for providing AR acquires real space information, user information, and object information in 600. Subsequently, the apparatus recognizes a real object by using the real space information and the user information, recognizes a real environment including a user's movement from the recognized real object, calculates an interaction between the recognized real environment and a virtual environment, combines the virtual environment with the real environment, and accordingly generates augmented content in 610. Subsequently, the apparatus projects and visualizes the generated augmented content through a projector in 620. The operations 610 and 620 may be performed according to a content scenario in 630.

In the operation 610, the apparatus may recognize an object by analyzing real space through image processing and machine learning which are performed based on real space information including depth information and point cloud information. The apparatus calculates an interaction between real space and virtual space through learning data, divides space by using a three-dimensional background model that is made in advance and simplified in order to improve a reaction speed, executes pre-matching for each divided space, and accordingly searches for an area, which is good enough for an object to be added to, on space where the augmented content will be represented.

The apparatus searches for mapping parameters between real space and virtual space and combines them, so that the real space and the virtual space may be equally mapped. The apparatus trains and registers a three-dimensional background model that is made in advance and simplified, then searches for an object location on space, where augmented content will be represented, by using real space information and user information, and replaces the searched object location with a virtual object mesh that is made in advance and simplified, thereby representing the augmented content. In a case where the augmented content is projected to a user's body, the virtual object mesh that is made in advance and simplified may be rendered as it is in the three-dimensional space by using user body information.

Furthermore, the apparatus may share and synchronize augmented content with other users in remote areas, so they experience the augmented content together.

FIG. 7 is a reference diagram illustrating an example of acquiring user information according to an exemplary embodiment.

Referring to FIG. 7, when an additional input device is included, and projection is executed on a user's body, user information is acquired so that the augmented content may be precisely projected to be fit for the body. For example, body information that may give a user's skeleton information and a shape of each body part of the user is acquired. In a case where user information, which is the same as the user's body information, is acquired in advance, the user information may be used in augmented content, and the user information may be stored to be reused later.

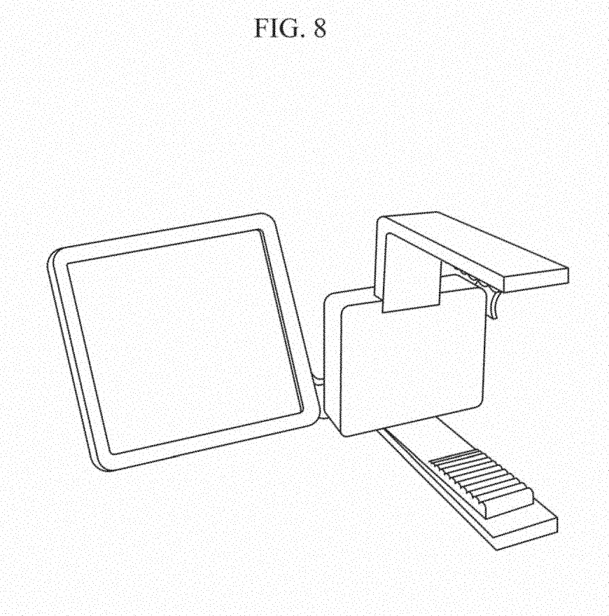

FIG. 8 is a diagram illustrating the outward appearance of a reflector of a projector according to an exemplary embodiment.

Referring to FIG. 8, a reflector of a projector includes an exclusive reflector for a projector and a stand where the projector is held. The reflector thereof enables light coming out from a beam projector to be projected in the desired location. It may be possible to project augmented content to wider space with a less number of projectors through the following operations in order to secure a wider projection area: increasing a projection distance through mirror reflection to enlarge a projection surface; or making a reflection surface with a curvature proper for the projection surface by using a 3D printer and executing mirror reflection coating here.

In one exemplary embodiment, an apparatus for providing projection mapping-based AR may enable an interaction between a virtual environment and a real environment, represented through a projection mapping technique, to be performed, thereby providing a realistic augmented content. Based on this, the projection to a user's body or various predefined object surfaces may enlarge a representation range of the augmented content. In addition, it is possible to create new-concept play space, where the apparatus adds a real object to the inside of space and makes it recognized with users existing in remote areas, so the augmented content is used.

Furthermore, there is no inconvenience of wearing a display, such as head mounted display (HMD) to propose absorption-based augmented content, and it is effective that beyond the limit in experience space by a limited display visualization area, such as TV, a number of people have experiences together through the augmented content and a realistic interaction in wider space.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for providing augmented reality (AR), the apparatus comprising:
an input configured to acquire real space information and user information; and
a processor configured to recognize a real environment by using the acquired real space information and the acquired user information, map the recognized real environment to a virtual environment, generate augmented content that changes corresponding to a change in space or a user's movement, and project and visualize the generated augmented content through a projector.

2. The apparatus of claim 1, wherein the input is configured to acquire in advance the user information comprising a user's skeleton information and body information of each body part; and
the processor is configured to use the user information so that when the augmented content is projected to a user's body, the augmented content matches the user's body.

3. The apparatus of claim 1, wherein the input is configured to:
acquire point cloud information of three-dimensional space with regard to real space in which a user and a three-dimensional item model are all removed, match the point cloud information to a three-dimensional background model that is made in advance to be simplified, and register the matched information; and
acquire an image and a depth information map regarding each three-dimensional item model used in the augmented content, as well as point cloud information that is made using the image and the depth information map, match the point cloud information to the three-dimensional background model, and register the matched information.

4. The apparatus of claim 1, wherein the processor comprises:
an interaction processor configured to recognize an object by using the real space information and the user information, recognize the real environment comprising the user's movement from the recognized object, calculate an interaction between the recognized real environment and the virtual environment, combine the virtual environment with the real environment, and accordingly generate the augmented content, and
a projection visualizer configured to project and visualize the augmented content, generated by the interaction processor, through the projector.

5. The apparatus of claim 4, wherein the interaction processor is configured to recognize the object by analyzing real space through image processing and machine learning which are performed based on the real space information comprising depth information and point cloud information.

6. The apparatus of claim 4, wherein the interaction processor is configured to:
calculate the interaction between real space and virtual space, divide space by using a three-dimensional background model that is made in advance and simplified in order to improve a reaction speed, perform pre-matching for each divided space, and search for an area, which is good enough for the object to be added to, on space where the augmented content is to be represented.

7. The apparatus of claim 4, wherein the projection visualizer is configured to acquire mapping parameters between real space and virtual space, and combine the mapping parameters so that the real space and the virtual space are mapped equally.

8. The apparatus of claim 4, wherein the projection visualizer is configured to represent the augmented content by training and registering a three-dimensional background model that is made in advance by the input and simplified, searching for an object location on space, where the augmented content is to be represented, by using data acquired by the input, and replacing the searched object location with a virtual object mesh that is made in advance and simplified.

9. The apparatus of claim 4, wherein the projection visualizer is configured to in response to the augmented content being projected to a user's body, render a virtual object mesh in three-dimensional space without any change by using user body information acquired in advance by the input, wherein the virtual object mesh is made in advance and simplified.

10. The apparatus of claim 4, wherein the projection visualizer is configured to perform edge blending and masking on an image to process an area overlapped by several projectors.

11. The apparatus of claim 4, wherein the processor further comprises:
a content sharing processor configured to share and synchronize the augmented content with other users existing in remote areas so that the users experience the augmented content together.

12. The apparatus of claim 4, wherein the processor further comprises:
a content logic processor configured to support the augmented content to progress according to a scenario logic, and provide augmented content visualization data to the projection visualizer.

13. A method of providing AR, the method comprising:
acquiring real space information and user information;
recognizing an object by using the acquired real space information and the acquired user information, recognizing a real environment comprising a user's movement from the recognized object, calculating an interaction between the recognized real environment and a virtual environment, combining the virtual environment with the real environment, and accordingly generating augmented content; and
projecting and visualizing the generated augmented content through a projector.

14. The method of claim 13, wherein the acquiring of the real space information and the user information comprises:
acquiring point cloud information of three-dimensional space with regard to real space in which a user and a three-dimensional item model are all removed, matching the point cloud information to a three-dimensional background model that is made in advance to be simplified, and registering the matched information; and
acquiring an image and a depth information map regarding each three-dimensional item model used in the augmented content, as well as point cloud information that is made using the image and the depth information map, matching the point cloud information to the three-dimensional background model, and registering the matched information.

15. The method of claim 13, wherein the generating of the augmented content comprises recognizing an object by analyzing real space through image processing and machine learning, which are performed based on the real space information comprising depth information and point cloud information.

16. The method of claim 13, wherein the generating of the augmented content comprises:
calculating the interaction between real space and virtual space, dividing space by using a three-dimensional background model that is made in advance and simplified in order to improve a reaction speed, performing pre-matching for each divided space, and searching for an area, which is good enough for the object to be added to, on space where the augmented content is to be represented.

17. The method of claim 13, wherein the generating of the augmented content comprises:
acquiring mapping parameters between real space and virtual space, and combining the mapping parameters together so that the real space and the virtual space are mapped equally.

18. The method of claim 13, wherein the generating of the augmented content comprises:
representing the augmented content by training and registering a three-dimensional background model that is made in advance and simplified, by searching for an object location on space, where the augmented content is to be represented, using the real space information and the user information, and by replacing the searched object location with a virtual object mesh that is made in advance and simplified.

19. The method of claim 13, wherein the generating of the augmented content
in response to the augmented content being projected to a user's body, render a virtual object mesh as it is in three-dimensional space by using user body information, wherein the virtual object mesh is made in advance and simplified.

20. The method of claim 13, wherein the method further comprises:
sharing and synchronizing the augmented content with other users existing in remote areas so that the users experience the augmented content together.
